(19) United States
(12) Patent Application Publication
(10) Pub. No.: US 2011/0301976 A1
(43) Pub. Date: Dec. 8, 2011

(54) MEDICAL HISTORY DIAGNOSIS SYSTEM AND METHOD

(75) Inventors: Michelle Davis, Raleigh, NC (US); Eric A. Stegner, Durham, NC (US)

(73) Assignee: INTERNATIONAL BUSINESS MACHINES CORPORATION, Armonk, NY (US)

(21) Appl. No.: 12/793,110

(22) Filed: Jun. 3, 2010

(51) Int. Cl. G06Q 50/00; G06N 5/02

(52) U.S. Cl. 705/3; 705/2; 706/50

(57) ABSTRACT

An intelligent system for collecting, storing, processing, and analyzing a patient's relevant medical history data is disclosed. In one embodiment, a patient's medical history, including the patient's personal medical history and the patient's family medical history, may be accessed within the system. The system may be queried by doctors and other medical professionals to compare symptoms, diagnoses, prescriptions, and medical issues against the known medical history. Further, the intelligent system may query the medical history of family members, providing an accurate yet discreet evaluation of related health conditions that may have genetic or hereditary implications. A further embodiment utilizes the intelligent system to generate alerts on the basis of the patient's personal or family medical history. These alerts may be issued separately or in conjunction with the patient's current medical issues, in order to help patients and medical professionals recognize potential health conditions and obtain enhanced medical evaluation.

### FIELD OF THE INVENTION

The present invention generally relates to information processing performed in connection with medical diagnosis and treatment. The present invention more specifically relates to techniques for assisting the diagnosis and treatment of a medical condition through the use of a patient's personal and family medical history.

### BACKGROUND OF THE INVENTION

A number of problems have developed in conjunction with the use of medical data and medical records in traditional medicine diagnosis settings. First, many patients feel disconnected from their personal medical data. Even though patients are providing more relevant health information than ever before to their healthcare providers, often times medical professionals do not have a way to sort through this data and determine which data is most relevant. Second, changes in the practice of medicine have resulted in healthcare providers that are not well-aware of a patient's medical history. There is a growing trend to move away from family/general practice doctors who are familiar with the patient over a period of years to more specialized health care providers that treat discrete health conditions. As patients move from specialist to specialist, background medical data relevant to the patient may be easily lost or ignored.

Despite a steady increase in the use and availability of medical data, in many settings, specialized practitioners do not have the time or background with the patient to process all aspects of a patient's relevant medical history. A patient's family medical history is particularly valuable in order to recognize hereditary and genetic predispositions that result in predictable medical issues or complications. Further, even though most doctors ask for relevant personal medical history from their patients prior to treatment, many patients may have medical history gaps or may forget important details. As medical treatments become more complex, the demand for better access to all relevant personal and family medical records will only increase.

Currently, there is not an easy way to use an intelligent diagnostic methodology when a medical issue occurs, especially when pulling all relevant patient information produces incomplete data. Therefore, doctors may not be alerted to all potential issues using a standard diagnosis protocol. With the high costs and risks associated with the lack of information when making diagnostic decisions, it is evident that historical medical data relevant to the patient needs to be processed in a better fashion.

One technique that increases the accessibility and use of medical records is the use of portable electronic medical records, such as records accessible through electronic credit card-shaped cards having bar coding or smartcard technology. These portable cards provide a patient with reliable access to his or her medical history at any time. With a portable smartcard, however, there is a chance for the data to be lost or stolen. Depending on the technology, there may also be privacy concerns, or laws may prevent generating portable data records that provide a comprehensive view of all relevant medical data. Depending on the software, portable records may not be consistent or cost efficient to implement. Patients may forget or may not be willing to carry their health information with them.

Other applicable technology includes products that try to manage the collection, consolidation, and maintenance of a patient's medical data. For example, a number of electronic medical record systems capture relevant medical data, and may be accessed by multiple locations and doctors. While this data is captured, there is no diagnostic mechanism in place that not only uses the data but also applies smart analytics to such data. Further, existing technologies do not provide a sufficient basis for a doctor to review background data quickly and in a comprehensive manner, obtain diagnostic information for relevant medical conditions, or otherwise extract usable and concrete recommendations on the basis of a patient's relevant medical history.

### BRIEF SUMMARY OF THE INVENTION

One aspect of the presently described invention involves the use of a “diagnostic intelligence system” that pulls patient and family medical histories relevant to a patient, and produces healthcare suggestions and actions relevant to the patient's medical condition. Rather than requiring a self-submission of medical history at each healthcare provider, the intelligent system is used to store, query, and extract relevant background medical history data using a set of interfaces. This is performed without infringing on patient privacy, as the data is processed in background processes and away from the patient and doctor's office.

Another aspect of the invention provides the diagnostic intelligence system with access to the patient's immediate and extended family health information (e.g., medical history data obtained from biological relatives such as parents, aunts, uncles, siblings, children, cousins, and grandparents) for use in diagnosing the patient's current or potential medical issues. The family health information also may be stored at the level of the intelligent system, and may be updated over time as the patient's family members encounter their own medical issues and treatments. This family health information may be queried as necessary and compared to the patient's current symptoms, diagnosis, and treatment. The use of such medical history in the intelligence system may be designed to comply with various state and federal privacy regulations, such as HIPPA. As further described herein, leveraging medical history information from other family members within the intelligence system includes providing an adequate system infrastructure, system setup, system analysis, and system updates for access and use of the family health information.

The presently disclosed diagnostic intelligence system therefore provides one location to access all of a patient's relevant medical history as well as the patient's family histories, while avoiding privacy or portability issues. The system is able to process all of the inputs separately or in combination, and may suggest diagnoses and treatment course of actions, identify patterns in previous treatment history, and alert a practitioner to hereditary medical conditions or underlying causes. Therefore, the practitioner seeing the patient may be presented with more context to the patient's background, ultimately leading to better diagnoses and reductions in the costs and risks of medical treatments.

For example, when a health care provider queries the system, the intelligent system determines based on its available information how to intelligently diagnose the patient. This is provided through the use of algorithms and heuristics which mine the patient's medical history and family history. The diagnostic intelligence system then flags any potential issues based on the recommended treatments and standard diagnostic protocols. A further embodiment also allows interaction with the practitioner to drill down to specific conditions and results, and to update the history data stored in the intelligent system with additional medical data.

A further aspect of the present invention utilizes the family history medical data to set up proactive medical alerts, even when the patient is healthy or is not currently experiencing a medical condition. The diagnostic intelligence system may trigger alerts on the basis of life events, developing patterns in a family, or the onset of specific medical conditions (even unrelated medical conditions). Focusing on a patient's personal medical history as well as the patient's family histories allows a combined view of the patient's overall risk factors and the future medical conditions that the patient may face. By using the presently disclosed diagnostic intelligence system to query and compile family history, the computer system may also avoid privacy concerns from the handling of other persons' medical data by unauthorized practitioners. Further, the diagnostic intelligence system may use the combination of alerts and predicted medical conditions to suggest and monitor proactive treatment and health maintenance activities.

In one specific embodiment described herein, a method for analyzing medical history in a diagnostic intelligence system is provided to assist with assessment and treatment of a patient's medical condition. This method includes accessing medical information relevant to the patient with a diagnostic intelligence system, the medical information including personal medical history and family medical history of the patient. This family medical history includes information compiled directly from personal medical histories of known immediate and extended family members of the patient. The analysis includes querying the medical information with the diagnostic intelligence system to retrieve and filter relevant background information related to the patient's medical condition, including medical information retrieved from the family medical history. This relevant background information is provided to a healthcare provider in connection with a patient consultation.

Observations and assessments of the patient's condition are provided by the healthcare provider to the diagnostic intelligence system. The diagnostic intelligence system compares the relevant background information to the observations and assessments, and may produce recommendations, request follow-up actions, or verify a diagnosed medical condition. Information for diagnoses, tests, and treatments originating from the patient consultation is also recorded in the intelligent system. In further embodiments, medical data and/or medical records of the patient are updated with the results of the physician-patient consultation. As further described herein, the relevant medical data may exist in a variety of formats and be retrieved from a variety of locations; and the medical provider may be a general medical practice, a specialist medical practice, a hospital medical system, or other facilities and medical practices.

Additionally, in a further embodiment, a diagnostic assessment is performed on potential root causes of the patient's medical condition using the diagnostic intelligence system. This may be followed by providing information on the potential root causes to the medical provider in connection with the patient consultation. Thus, the diagnostic intelligence system may be used at multiple points in a typical patient treatment workflow, before, after, and during a physician visit, and using its intelligence system to assist both medical professionals and patients with relevant information and intelligence queries.

Another specific embodiment of the invention provides a method of generating and issuing healthcare alerts to a patient that are relevant to a patient's health condition. This includes accessing medical information such as personal and family medical history relevant to the patient. The medical information is queried using the diagnostic intelligence system to retrieve relevant background information concerning a potential health condition, and to evaluate risk factors for the potential health condition.

A healthcare alert may be provided to the patient regarding the potential health condition responsive to determining a sufficient level of risk factors. The patient's medical information and background information related to the healthcare alert and the potential health condition may be provided to a healthcare provider for evaluation, such as in a follow-up visit. Recommendations may be provided to the healthcare provider, suggesting one or more tests, treatments, or consultations with the patient to evaluate the potential health condition.

In one embodiment, the healthcare alert is provided to the patient in response to a healthcare consultation with the medical provider. In another embodiment, the healthcare alert is provided proactively and prior to any healthcare consultation with the medical provider.

Other specific embodiments of the present invention provide for a diagnostic intelligence computing system, including a processor, a memory unit, a data store, and instructions executed within the computing system for analyzing medical history in conjunction with assessment and treatment of a patient's medical condition as described herein. Another specific embodiment provides a similar diagnostic intelligence computing system, with instructions executed within the computing system for generating and issuing relevant healthcare alerts to a patient. Other specific embodiments of the present invention provide for a computer program product for operating an intelligent diagnostic system, with the computer program product comprising a computer readable storage medium having computer readable program code embodied therewith to implement the various techniques described herein.

### BRIEF DESCRIPTION OF THE DRAWINGS

FIG. 1 depicts a typical medical diagnosis workflow;

FIG. 2 depicts a medical diagnosis workflow including querying a patient diagnostic intelligence system according to an embodiment of the present invention;

FIG. 3 depicts a medical diagnosis workflow including providing medical alerts from a patient diagnostic intelligence system according to an embodiment of the present invention; and

FIG. 4 depicts the interaction between a patient diagnostic intelligence system and interested parties according to an embodiment of the present invention.

### DETAILED DESCRIPTION OF THE INVENTION

One aspect of the presently disclosed invention includes providing an intelligent interface between a person's medical history and health care providers, enabling the providers to access all relevant patient medical history information in a matter of seconds. In most medical settings, physicians do not have immediate access to a patient's personal and/or family medical history. This decreases the physician's ability to offer the best proactive medical assessments and/or solutions for the patient. The following disclosed embodiments provide the ability to maintain and query an intelligent diagnosis system with access to this medical data, leveraging the use of a computer system to retrieve, filter, analyze, and produce the most relevant data. Therefore, use of this intelligent diagnostic system facilitates smarter ways to use a patient's medical history information in a variety of medical treatment and diagnosis settings, and make medical history data more usable in medical workflows.

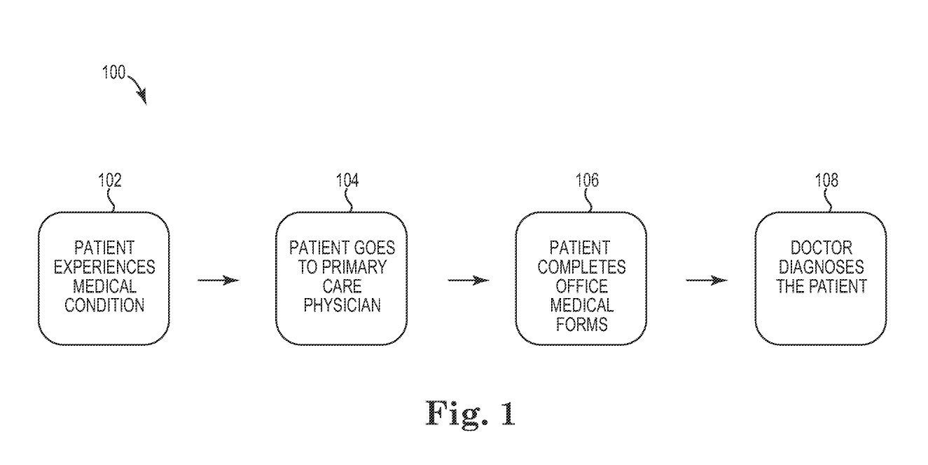

FIG. 1 provides an illustration of a typical medical diagnosis and treatment workflow 100. As shown, in step 102, a person experiences a medical condition. The person will seek out medical treatment, often going to a primary care physician or other generalist health care provider as in 104. When the person arrives at the physician's office, the person will be presented with a number of office medical forms as in 106, asking the person to provide information on past medical procedures, treatments, along with any known medical conditions for immediate and extended family members of the person. After this information is provided to the medical provider, the doctor or other medical professional will evaluate the person's medical condition and provide a diagnosis to the patient as in 108. Although the doctor will typically be provided with a copy of the person's completed medical history and family history, it is up to the doctor's discretion to consider whether this background information will have any effect on the diagnosis or the course of treatment. Further, the doctor may not have a sufficient amount of time to analyze the medical history information, or in many cases the information provided on the forms by the patient may be incomplete or inaccurate.

In contrast to this workflow, the presently disclosed invention provides a patient diagnostic intelligence system that collects and processes medical history information from the patient directly. This information may come from data stored within the diagnostic intelligence system, or from a variety of external sources such as other healthcare services or electronic medical record depositories. Additionally, the patient's family medical history information may be compiled from information stored in similar locations, from within the diagnostic intelligence system or from external sources.

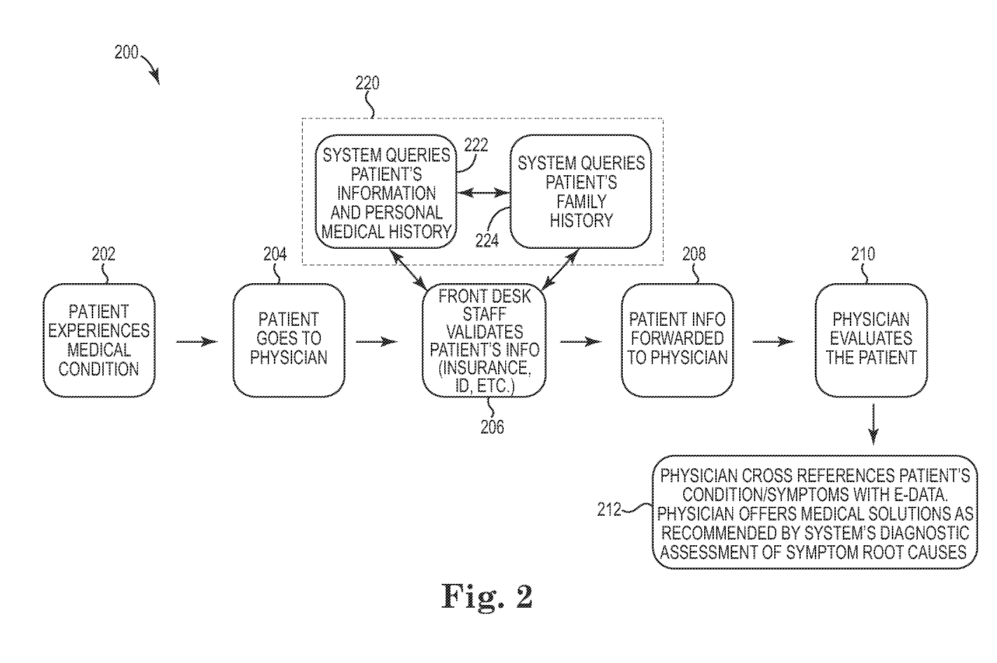

FIG. 2 provides an illustration of a medical diagnosis and treatment workflow 200 conducted with use of a patient diagnostic intelligence system in accordance with an embodiment of the presently described invention. As shown, certain steps are similar to that of a typical doctor visit, including experiencing a medical condition 202, going to a physician for treatment as in 204, and obtaining an evaluation from a physician as in 210. The intervening steps, however, provide interaction with a diagnostic intelligence system that has access to a patient's personal and family medical histories.

As shown, the patient provides identification information that is validated by staff of the medical practice as in 206. For example, information unique to the patient such as an insurance card, ID, and the like is provided to the medical provider to verify the patient's identity and gain access to a diagnostic intelligence system. Once the identification information is validated, the patient diagnostic intelligence system 220 is queried to obtain medical history information relevant to the patient. This may include querying the patient's information and personal medical history as in 222, and/or querying a patient's family history as in 224. The type of query may involve inquiring into general or specific medical conditions (for example, allowing a specific focus on types of medical history, such as prior conditions and treatment relating to the cardiovascular health of the patient and the patient's family when heart problems are the primary reason for visiting the healthcare provider).

The queried information is then provided to the medical practice, and is forwarded to the physician for review as in 208. Therefore, rather than relying on self-submitted information from patient on forms, or a interview from a nurse or physician, this information is compiled and potentially analyzed prior to the physician conducting his or her evaluation of the patient. As the physician evaluates the patient as in 210, the physician can factor this information when determining if a diagnosis can be excluded, the types of medications or treatments that may or may not be effective, whether any adverse results (such as allergies) may result from a suggested treatment, and the like. The physician's analysis may also include cross-referencing and comparing patient conditions or systems with general or specific information retrieved from the diagnostic intelligence system as in 212. The physician may also consider and use the medical solutions that are suggested by the system. For example, patterns in the patient or the patient's immediate family may indicate trends or recurring health conditions.

In one embodiment, an intelligent interface component (such as a standalone or web-based graphical user interface) is provided to allow healthcare providers to effectively interface with the patient diagnostic intelligence system. This intelligence interface includes a sophisticated environment for its users that can be leveraged by different types of medical professionals or the patient. For example, the interface may allow drill-down of specific data or medical conditions, to limit by anatomical subsystems (again, considering the cardiovascular system example above), age ranges, date ranges, gender of family members, or summaries of these categories of data.

Another embodiment of the intelligent interface enables the patient to directly access an interface that allows them to read and verify their background medical history, and even learn more about specific diagnoses or treatments. Thus, the patient may be given personal, yet hands-on view of their medical history and conditions, formatted for viewing by non-medical professionals.

The following non-limiting examples are provided as an example of how such a doctor or patient interface to the presently described patient diagnostic intelligence system may be presented. Further, the following examples demonstrate how usable information may be accessed and updated within the diagnostic intelligence system.

### EXAMPLE 1

The Physician accesses the diagnostic intelligence system using a physician interface and locates relevant background medical information for Patient A. The Physician inputs his or her recent diagnosis that was prepared for the Patient A on the basis of the physician's current evaluation. The system returns information that indicates if the diagnosis is a recurring item for the patient. It offers previous and currently recommended treatment plans for the diagnosis. If the physician enters a recommended treatment plan, the system can advise if it is a good course. If items in the patient's profile or medical history suggest that this treatment plan is adverse to the patient's health, the diagnostic intelligence system may offer alternative suggestions.

### EXAMPLE 2

Not only can the patient assess his or her medical history, authorize personal medical history access to other family, medical practitioners, and other interested parties, but the patient can use the interface for personal benefit and access the interface at regular intervals to maintain a healthy lifestyle. For example, the patient recently has visited a physician who offers a treatment plan that may sound questionable based on patient's knowledge of his or her medical history. The patient can log into system, view or enter the diagnosis, and review information relevant to the condition and suitable treatment plans. If the patient doesn't see his or her recommended treatment plan, the patient can input the treatment plan for system validation of effectiveness based on his or her medical history.

### EXAMPLE 3

As soon as the physician inputs the patient's treatment plan (including medication), the system automatically sends a prescription request to the patient's pharmacist. This will minimize/eliminate prescription wait time for the patient. Additionally, information stored within the pharmacist's computer system may be pulled and integrated into the intelligent diagnostic system. Therefore, a fuller view of information such as allergic reactions, past medications, and other concerns may be shared between the physician and pharmacist.

### EXAMPLE 4

Patient notes a recent symptom. Patient logs into the intelligent diagnostic system and enters his or her symptoms. The system may detail possible medical conditions and suggest recommended specialty physicians. If patient doesn't have a doctor, the system may list the nearest physicians favorably rated by other registered users, or filter doctor information based on insurance coverage or other considerations.

As those of ordinary skill in the art would recognize, numerous techniques and technologies may be utilized to provide patients and medical providers with access or interfaces to the diagnostic intelligence system. The following is a discussion of providing access through example patient and physician interfaces.

From the perspective of a medical professional accessing the diagnostic intelligence system, each physician would open an account or register to obtain access to the system. In one embodiment, each medical professional (doctor) would register to access the system via a network. The medical professional's history/credentials/identification may be verified before providing him or her with access to the system. Once approved for registration, physician access to the system would be granted.

Depending on any existing laws, the medical professional's office would work in conjunction with the diagnostic intelligence system to transfer medical records online. The access and transfer of the medical record and other confidential health information may be conducted in compliance with HIPPA and other applicable medical standards and privacy laws. Once logistics are worked out, the medical professional may also send out communications to patients making the patients aware of an online healthcare network including registration instructions, timeline of completed uploads, etc. Patients, when registering or first gaining access to the system, may opt in or agree to settings regarding access, use, and storage of medical records within the system.

In one embodiment, a medical professional may log into and access the diagnostic intelligence system via a network. The professional may log in and identify the appropriate through the use of a patient's name and social security number, or other suitable identifiers. If the patient has opted in to allow the medical professional with access to medical records via the service, then the professional will be allowed to move on to the various interface screens of the system and access the appropriate patient medical records.

Once the medical records are uploaded or otherwise provided to the diagnostic intelligence system, either of the medical professional/patient can log in to obtain and verify medical records. For example, if a medical professional obtains a new patient, the patient can provide written access to the medical practice or login at home and add the medical practice as an authorized user for access. Additionally, a further embodiment may enable an intelligent interface within the diagnostic intelligence system that would permit communication between the patient and the physician or other authorized users associated with the patient.

Other embodiments may also allow communication between medical professionals within the diagnostic intelligence system. For example, if a doctor has a question about a medical file item, he or she may submit messages within the interface to other of the patient's physicians as long as they are both registered and associated with the patient in the diagnostic intelligence system. Or, a medical professional may post prescriptions on the platform for the respective user. A registered pharmacist could go onto the system and pull the prescription, or a pharmaceutical prescription request could be messaged to the registered pharmacist once the doctor posts it to the system. The pharmacist may also see other information in the patient's medical history that is relevant to the patient's new prescription.

From a patient perspective, the interface to the diagnostic intelligence system may provide a number of unique features for directly interacting with the patient's health care services. Similar to the registration needed for medical professionals, a patient may be required to pre-register to gain access via a network interface. During this registration, the patient may indicate if his or her information may be used for diagnosing other family related issues, and if they would like to allow other family members, medical professionals, or interested parties with access to the health records. Once registered, they will be able to see all of their medical records and/or other functions associated with the user configured on the interface. Medical records may be categorized by doctor who uploaded records, the medical system, or other appropriate categories.

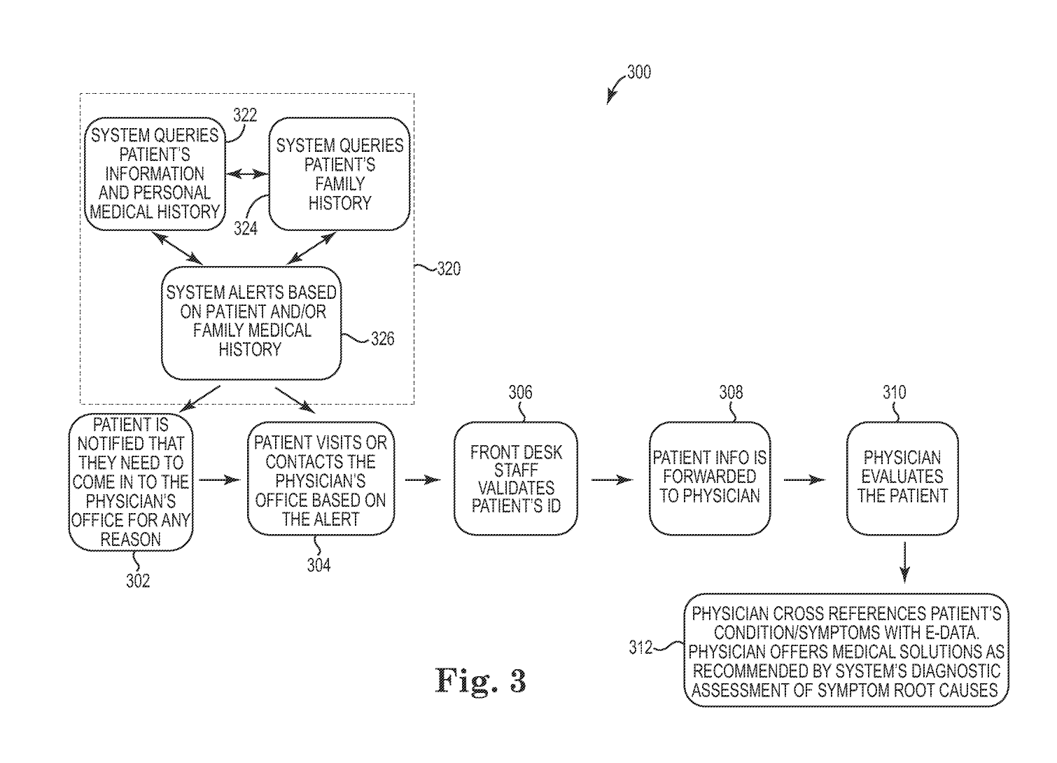

As described herein, a further aspect of the presently disclosed invention includes functionality to enable alerts to allow proactive suggestions for maintaining a patient's health. FIG. 3 provides an illustration of a medical diagnosis and treatment workflow 300 initiated through the use of alerts originating from a patient diagnostic intelligence system 320 in accordance with an embodiment of the presently described invention. The following description in conjunction with FIG. 3 illustrates an example scenario where alerts may be sent to patients and acted upon.

As shown, in 302, the patient is notified with an alert that he or she needs to visit the physician's office. This type of an alert may provide a direct reason for visiting the health care provider (e.g., “Visit your Doctor to test for Heart Problems”), or the alert may correspond to regularly scheduled physicals, a patient's age, calendar dates, or other appropriate triggers. Then, as in 304, the patient visits or contacts the physician's office based on the alert. Alternately, the timing of the alert may be initiated through patient contact to the physician's office, such as a patient visit or inquiry to address another health issue.

The content of the alert is determined by the diagnostic intelligence system 320. As shown in FIG. 3, the diagnostic intelligence system 320 combines two queries to generate relevant alerts, that being queries of a patient's information and personal medical history 322, and queries of a patient's family history 324. The diagnostic intelligence system would include the appropriate logic to ascertain and/or release the appropriate data as configurable into the system.

These queries may be conducted in a variety of ways. For example, once preliminary patient data is entered, the diagnostic information system may identify all external data sources tied to the given patient as well as any direct family member associated with the patient. Once the diagnostic information system identifies all external sources, it uses logic to begin the querying of all information tied to the patient and patient's family. After receiving the respective information, the logic conducts a self-check and saves/update any information gaps not currently housed in the diagnostic information system. As the diagnostic information system is updated, it goes through a categorization logic searching for relevant categorical items and providing any outputs respective to the latest inputs. As the diagnostic information system receives updates from any given source, it may also provide those recent updates real time to the relevant electronic medical sources currently linked to the diagnostic information system for the patient.

Once the queries are complete, the intelligence system 320 then processes the information obtained to produce alerts 326 on a variety of criteria. For example, the appropriate criteria may be based on developing trends in family history (such as the system recognizing that each family member over the age of 50 has diabetes, and encourages the patient upon their 50th birthday to seek out a medical checkup for diabetes).

The remainder of the workflow is similar to the processes previously described. As shown, in 306 the medical professional's office will validate the patient's identification; patient information will be forwarded to the physician as in 308, and the physician will evaluate the patient as in 310. Based on the information in the alerts and other information retrievable from the diagnostic intelligence system, the physician may cross-reference the patient's conditions and systems with retrieved information as in 312. Further, the physician may offer medical solutions as recommended by the intelligence system's diagnostic assessment of root causes and history trends as in 312.

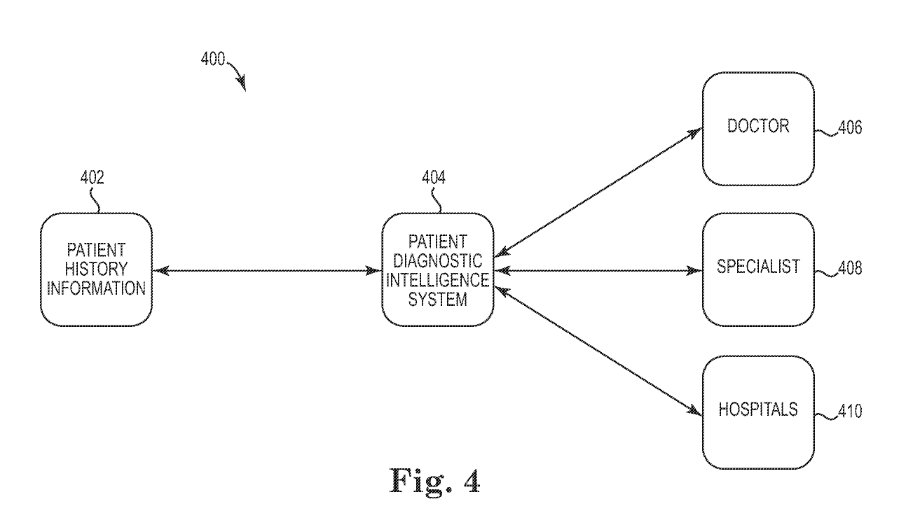

FIG. 4 provides a summarized illustration of the interactions 400 between the presently described patient diagnostic intelligence system and interested parties according to an embodiment of the invention. As shown, patient history information 402 is provided to and retrieved from the patient diagnostic intelligence system 404. This patient information history may be continually updated based on information provided by interested parties. Thus, relevant history for the patient may be updated over time to create a more complete picture of the patient's medical history and medical condition. Further, as the patient or providers have gaps in their understanding of the patient and the patient's family history, the patient diagnostic intelligence system 404 may be updated by the patient to include missing information.

As previously described, the patient diagnostic intelligence system pulls current patient history collected from a variety of data sources. Access to information within the system may be obtained through validation criteria based on unique fields such as social security number, date of birth, address, eye color, and the like. The system may also gather similar information for the patient that is stored for patient family members (parents, siblings, etc). The system therefore associates the patient with a set of family relationships if family medical data is available. Finally, consistent with the medical workflows previously described, the diagnostic intelligence system 404 looks at the current health issue and analyzes input to the potential reasons for the visit, including family history, current medications, and other information, and may alert the care providers such as 406, 408, 410 with issues to be concerned with based on the history.

As shown, the patient diagnostic intelligence system may be accessed by numerous healthcare providers, including doctors 406 such as primary care or general practice physicians; specialists 408; and hospitals and facility-based care settings 410. Each of these healthcare providers may interface with the patient diagnostic intelligence system using the previously described interfaces in order to retrieve relevant data and update the records maintained within the patient diagnostic intelligence system. Information systems within the medical facilities and practices of doctor 406, specialist 408, and hospitals 410 may retrieve and update the diagnostic intelligence system with current patient treatment and records. Care providers continue to provide service to the patients and the patient information is shared back and stored in the diagnostic system. This care information is then compiled into to the patient history and used in subsequent care without directly infringing on patient privacy of the medical records.

As suggested above, the presently described patient diagnostic intelligence system may also interface with other systems which maintain electronic medical records for the patient and the patient's family. The type and location of interaction may occur based on a categorization of the medical issue and/or alert. The diagnostic intelligence system may pull the respective information from the relevant queried databases and offer a confidence level in order to validate the retrieved data.

As an example of categorization, suppose that a patient has a heart issue. The system queries all available data associated with a relevant category such as cardiovascular or heart-related information from the patient's individual or family medical history, which may be located in a variety of different locations. Additionally, once registration is completed by a physician(s)/health care provider/hospital system, access would be granted for its qualifying electronic medical records and information systems to begin a two-way communication with the diagnostic intelligence system.

The diagnostic intelligence system may also be synchronized with the external medical record sources to either upload and fill-in information gaps for a given individual, or release medical information to the respective medical sources (such as third party medical software systems, etc.) The diagnostic intelligence may locate and access the appropriate medical files by looking for pre-configured pointers of the external source, and synchronizing the patient's medical file accordingly. This may also be performed through any of a variety of known medical record synchronization techniques and standards as known in the art. Therefore, the information stored in the disparate electronic medical record sources may be updated over time through use of the diagnostic intelligence system.

The infrastructure of the diagnostic intelligence system may include (but is not limited to) use of Cloud Computing, Portals, Client-Server systems, or any other suitable means to facilitate the presently disclosed invention. For example, Cloud Computing techniques provide the ability to scale architecture over the internet, and may include one or more clouds in order to leverage patient and/or patient family medical histories. There are several techniques that can utilize clouds to capture and diagnose such data. For example, a cloud can be built to capture all medical histories (patient and family) while another cloud is built for analytics and diagnostic functions. These two clouds as combined or as a result of any feeds directed from the clouds would result in the analytic function of such medical history data. As another example, one cloud is created to capture all medical history data as the base of the cloud. Then, the diagnostic platform features can be built on top of the cloud.

Additionally, as the presently disclosed diagnostic intelligence system encompasses the use of system architecture over the internet, multi-level security measures such as security passwords, assignable unique ids, and data masking technologies along with security questions can be utilized to address privacy and HIPPA compliance. Further, a prerequisite to use of the diagnostic intelligence system may include initial patient agreement forms that must be signed by the patient before he or she can proceed to use the system or access certain data. The permission forms may be sliceable and limited based on the applicable State regulatory requirement(s), allowing the patient to either agree/decline to use the system, or avoid certain features within the system.

In one embodiment, all information shared within the diagnostic intelligence system is communicated via an encrypted network utilizing strong passwords, keys, and security questions. The encrypted means ensures another layer of security, and provides effective accountability controls. History audit logs may be enacted in order to document all system activity for a given patient (date, time, accessed by, etc.). The captured information is not subject or limited to who accessed the information, when, and the data obtained through the system. For example, HIPPA requires up to six years of system activity history, but the system may be adapted to store this information in accordance with any applicable regulatory changes. Additionally, the system may enable a given patient to easily request what information (if any) was electronically accessed or distributed to a particular party with considerations of date and time.

Validation controls may also be included to ensure that medical practitioners provide required credentials and identity. Because legal regulations such as HIPPA impose certain obligations on how data is used and protected, the user would be able to grant or remove authorization to the associated health care providers via on-line and/or hard copy authorization forms. Without patient authorization, the health care provider would not be able to access the patient's personal medical history from the diagnostic intelligence system. For example, a patient goes to the hospital for condition A, which is addressed by specialist A. Once specialist A is granted access to the patient's medical history in the system, no other specialist/health care provider could access the patient's information relating to this condition even though they may routinely use the system for their other patients. If permissions expire after a given time (as mandated by the regulatory authority), the diagnostic system may send a notification (such as an email) to each user within a configurable amount of time before expiration. The user would access the system and complete additional permissions to allow continued use of the diagnostic intelligence system.

In one embodiment of the invention, a web portal is also provided to present information from numerous sources in a structured manner, while also allowing access controls and procedures for multiple applications and databases. The web portal may include security measures for cloud computing. Each patient receives an individualized unique id and password to use the web portal at setup. After completing the initial levels of security, the patient receives access to the portal. The patient completes his/her profile within the portal. Within this profile, the patient is requested to validate personal information, medical physicians/specialists or any other health provider. Also, the patient validates and/or inputs his or her medical history which is organized categorically. In addition, the patient can select user preferences as well as permissions with regards to family medical history data.

In a further embodiment, these permissions would require receipt of other family members' unique identifiers, which could map to a unique identifier for the family member so that the patient ensures that the correct identifier is entered into the system. Deferment should be to globally unique identifiers because simple identifiers such as social security numbers may be ultimately recycled. Once the information is validated and accepted by the patient, information relating to the patient family member is permanently transparent to the patient. The patient can send, receive and accept/reject family requests in order to link up profiles. Further, the patient can also select a duration for sharing personal health information with family members, which family members have access, and what level of access or type of information is accessible by family members. Data masking technologies are utilized to ensure privacy for all users.

From a system analysis perspective, the diagnostic intelligence system continuously monitors and updates itself regardless of its architectural mode. It monitors for alerts and/or changes as medical updates occur for each known family member. The system synchronizes those updates with all family member related patients that are linked up to the family member. System updates/monitoring includes but is not limited to the following: individual/family alerts and changes, individual/family historical data, and upcoming individual/family health scheduled appointments. In addition, there may be system generated alerts based on calculated severity (weighted calculation of each event based on individual and family medical history). For example, the number of events, when it occurs, at what age and family history outcome describes what identifiers can be included in a weighted calculation. The alerts do not identify whom in the extended family the data derives from. A prioritized list of diagnostics paths/options is generated by the system that is driven by any analysis of available family medical history.

As previously suggested, with regard to system updates, the following scenario is a typical example of how information may be updated within the diagnostic intelligence system. A physician examines the patient. The physician prepares the preliminary diagnosis based on patient examination. The physician inputs the data into the system which previously provided all patient family medical history. The system performs analysis on the data and provides the relevant diagnosis/options. The physician selects and/or updates the history record for the individual history which syncs up with all linked family medical history profiles. The system receives the inputs, processes the inputs, and continues to analyze the new information. The invention has the functionality to link relationships between users based on user inputs. The capability is needed in order to prioritize alerts for any given medical condition. Thus, as evident from this example, relevant medical information may be obtained for and propagated from both the individual and his or her family members.

As will be appreciated by one of ordinary skill in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method for analyzing medical history in a diagnostic intelligence system to assist with assessment and treatment of a patient's medical condition, comprising:
accessing medical information relevant to the patient with a diagnostic intelligence system, the medical information including:
personal medical history of the patient; and
family medical history compiled from personal medical histories of one or more biological relatives of the patient;
querying the medical information with the diagnostic intelligence system to retrieve relevant background information related to the patient's medical condition;
providing the relevant background information to a healthcare provider in connection with a patient consultation with the healthcare provider;
comparing, using the diagnostic intelligence system, the relevant background information with observations and assessments of the patient's medical condition to produce recommendations, the observations and assessments provided to the diagnostic intelligence system by the healthcare provider;
providing the recommendations to one or both of the patient and the healthcare provider; and
recording medical data in the diagnostic intelligence system for one or more of diagnoses, tests, and treatments originating from the patient consultation with the healthcare provider.

2. The method of claim 1, wherein the personal medical histories of the one or more biological relatives of the patient are linked to the patient within the diagnostic intelligence system through use of unique identifiers.

3. The method of claim 1, further comprising updating the medical information of the patient using the diagnostic intelligence system in response to the patient consultation with the healthcare provider.

4. The method of claim 1, wherein accessing medical information relevant to the patient includes accessing and incorporating use of electronic medical record data into the diagnostic intelligence system.

5. The method of claim 1, wherein the medical information relevant to the patient is stored in a data store of the diagnostic intelligence system.

6. The method of claim 1, further comprising performing a diagnostic assessment on potential root causes of the patient's medical condition with the diagnostic intelligence system and providing information on the potential root causes to the medical provider in connection with the patient consultation.

7. The method of claim 1, wherein the medical provider is one or more of a general medical practice, a specialist medical practice, and a hospital medical system.

8. A method for providing healthcare alerts to a patient relevant to the patient's potential health condition, comprising:
accessing medical information relevant to the patient with a diagnostic intelligence system, the medical information including:
the patient's personal medical history; and
family medical history compiled from personal medical histories of one or more biological relatives of the patient;
querying the medical information using the diagnostic intelligence system to retrieve relevant background information concerning a potential health condition;
evaluating risk factors for the potential health condition using the diagnostic intelligence system;
providing a healthcare alert to the patient regarding the potential health condition responsive to determining a sufficient level of risk factors;
providing the patient's medical information and background information related to the healthcare alert and the potential health condition to a healthcare provider for evaluation; and
issuing recommendations to the healthcare provider to conduct one or more tests, treatments, and consultations with the patient to evaluate the potential health condition.

9. The method of claim 8, wherein providing a healthcare alert to the patient occurs in response to a healthcare consultation with the medical provider.

10. The method of claim 8, wherein providing a healthcare alert to the patient occurs proactively and prior to a healthcare consultation with the medical provider.

11. A medical diagnostic intelligence system, comprising:
an information store for maintaining medical data for a plurality of patients;
at least one processor;
at least one memory store having instructions operable with the at least one processor for analyzing medical history of a patient to assist with production of a medical diagnosis, the instructions being executed for:
accessing medical information relevant to the patient with a diagnostic intelligence system, the medical information including:
personal medical history of the patient; and
family medical history compiled from personal medical histories of one or more biological relatives of the patient;
querying the medical information with the diagnostic intelligence system to retrieve relevant background information related to the patient's medical condition;
providing the relevant background information to a healthcare provider in connection with a patient consultation with the healthcare provider;
comparing, using the diagnostic intelligence system, the relevant background information with observations and assessments of the patient's medical condition to produce recommendations, the observations and assessments provided to the diagnostic intelligence system by the healthcare provider;
providing the recommendations to one or both of the patient and the healthcare provider; and
recording medical data in the diagnostic intelligence system for one or more of diagnoses, tests, and treatments originating from the patient consultation with the healthcare provider.

12. The system of claim 11, wherein the personal medical histories of the one or more biological relatives of the patient are linked to the patient within the diagnostic intelligence system through use of unique identifiers.

13. The system of claim 11, further comprising updating the medical information of the patient using the diagnostic intelligence system in response to the patient consultation with the healthcare provider.

14. The system of claim 11, wherein accessing medical information relevant to the patient includes accessing and incorporating use of electronic medical record data into the diagnostic intelligence system.

15. The system of claim 11, wherein the medical information relevant to the patient is stored in a data store of the diagnostic intelligence system.

16. The system of claim 11, further comprising performing a diagnostic assessment on potential root causes of the patient's medical condition with the diagnostic intelligence system and providing information on the potential root causes to the medical provider in connection with the patient consultation.

17. The system of claim 11, wherein the medical provider is one or more of a general medical practice, a specialist medical practice, and a hospital medical system.

18. A medical diagnostic intelligence system, comprising:
at least one processor;
at least one memory store having instructions operable with the at least one processor for providing proactive healthcare alerts to a patient relevant to the patient's potential health condition, the instructions being executed for:
accessing medical information relevant to the patient with a diagnostic intelligence system, the medical information including:
the patient's personal medical history; and
family medical history compiled from personal medical histories of one or more biological relatives of the patient;
querying the medical information using the diagnostic intelligence system to retrieve relevant background information concerning a potential health condition;
evaluating risk factors for the potential health condition using the diagnostic intelligence system;
providing a healthcare alert to the patient regarding the potential health condition responsive to determining a sufficient level of risk factors;
providing the patient's medical information and background information related to the healthcare alert and the potential health condition to a healthcare provider for evaluation; and
issuing recommendations to the healthcare provider to conduct one or more tests, treatments, and consultations with the patient to evaluate the potential health condition.

19. The system of claim 18, wherein providing a healthcare alert to the patient occurs in response to a healthcare consultation with the medical provider.

20. The system of claim 18, wherein providing a healthcare alert to the patient occurs proactively and prior to a healthcare consultation with the medical provider.
